(19) United States
(12) Patent Application Publication
(10) Pub. No.: US 2024/0333432 A1
(43) Pub. Date: Oct. 3, 2024

(54) HIGHER LAYER HALF DUPLEX OPERATION

(71) Applicant: Nokia Technologies Oy, Espoo (FI)

(72) Inventors: Navin HATHIRAMANI, Dallas, TX (US); Rapeepat RATASUK, Naperville, IL (US)

(21) Appl. No.: 18/612,481

(22) Filed: Mar. 21, 2024

Related U.S. Application Data
(60) Provisional application No. 63/455,200, filed on Mar. 28, 2023.

(51) Int. Cl. H04L 1/1812; H04L 5/16; H04W 72/1273; H04W 72/232

(52) U.S. Cl. CPC H04L 1/1812; H04L 5/16; H04W 72/1273; H04W 72/232

(57) ABSTRACT

A method for higher layer half duplex operation is provided. The method for higher layer half duplex operation may include receiving, from a serving cell, a configuration for a maximum number of downlink and/or uplink hybrid automatic repeat request processes. The method may also include providing an indication to the serving cell that includes a desired maximum number of uplink hybrid automatic repeat request processes based on an energy level of an apparatus and performing downlink control information monitoring for downlink or uplink until the maximum number of hybrid automatic repeat request processes is reached. The downlink control information monitoring may be suspended when a corresponding maximum number of downlink or uplink hybrid automatic repeat request processes is exceeded.

### TECHNICAL FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to higher layer half duplex operation.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Various exemplary embodiments may provide an apparatus including at least one processor and at least one memory storing instructions. The instructions, when executed by the at least one processor, cause the apparatus at least to receive, from a serving cell, a configuration for a maximum number of downlink and/or uplink hybrid automatic repeat request (HARQ) processes and provide an indication to the serving cell that comprises a desired maximum number of uplink hybrid automatic repeat request (HARQ) processes based on an energy level of the apparatus. The apparatus may be further caused to perform downlink control information (DCI) monitoring for downlink or uplink until the maximum number of hybrid automatic repeat request (HARQ) processes is reached. The downlink control information (DCI) monitoring may be suspended when a corresponding maximum number of downlink or uplink hybrid automatic repeat request (HARQ) processes is exceeded.

Certain exemplary embodiments may provide an apparatus including at least one processor and at least one memory storing instructions. The instructions, when executed by the at least one processor, cause the apparatus at least to determine that a user device with an unreliable power source based on an indication received from the user device and reconfigure a maximum number of hybrid automatic repeat request (HARQ) processes, and instruct the user device to operate in a half-duplex operation mode. The apparatus may be further caused to perform downlink control information (DCI) monitoring for downlink and/or uplink until the maximum number of hybrid automatic repeat request (HARQ) processes is reached. The downlink control information (DCI) monitoring may be suspended when a corresponding maximum number of downlink or uplink hybrid automatic repeat request (HARQ) processes is exceeded.

Some exemplary embodiments may provide a method including receiving, by an apparatus from a serving cell, a configuration for a maximum number of downlink and/or uplink hybrid automatic repeat request (HARQ) processes and providing an indication to the serving cell that comprises a desired maximum number of uplink hybrid automatic repeat request (HARQ) processes based on an energy level of the apparatus. The method may also include performing downlink control information (DCI) monitoring for downlink or uplink until the maximum number of hybrid automatic repeat request (HARQ) processes is reached. The downlink control information (DCI) monitoring may be suspended when a corresponding maximum number of downlink or uplink hybrid automatic repeat request (HARQ) processes is exceeded.

Various exemplary embodiments may provide a method including determining that a user device with an unreliable power source based on an indication received from the user device, and reconfiguring a maximum number of hybrid automatic repeat request (HARQ) processes and instruct the user device to operate in a half-duplex operation mode. The method may also include performing downlink control information (DCI) monitoring for downlink and/or uplink until the maximum number of hybrid automatic repeat request (HARQ) processes is reached. The downlink control information (DCI) monitoring may be suspended when a corresponding maximum number of downlink or uplink hybrid automatic repeat request (HARQ) processes is exceeded.

Some exemplary embodiments may provide an apparatus including means for receiving, from a serving cell, a configuration for a maximum number of downlink and/or uplink hybrid automatic repeat request (HARQ) processes and means for providing an indication to the serving cell that comprises a desired maximum number of uplink hybrid automatic repeat request (HARQ) processes based on an energy level of the apparatus. The apparatus may also include means for performing downlink control information (DCI) monitoring for downlink or uplink until the maximum number of hybrid automatic repeat request (HARQ) processes is reached. The downlink control information (DCI) monitoring may be suspended when a corresponding maximum number of downlink or uplink hybrid automatic repeat request (HARQ) processes is exceeded.

Certain exemplary embodiments may provide an apparatus including means for determining that a user device with an unreliable power source based on an indication received from the user device and means for reconfiguring a maximum number of hybrid automatic repeat request (HARQ) processes and instructing the user device to operate in a half-duplex operation mode. The apparatus may also include means for performing downlink control information (DCI) monitoring for downlink and/or uplink until the maximum number of hybrid automatic repeat request (HARQ) processes is reached. The downlink control information (DCI) monitoring may be suspended when a corresponding maximum number of downlink or uplink hybrid automatic repeat request (HARQ) processes is exceeded.

Various exemplary embodiments may provide a non-transitory computer readable medium comprising program instructions. The program instructions, when executed by an apparatus, may cause the apparatus at least to receive, from a serving cell, a configuration for a maximum number of downlink and/or uplink hybrid automatic repeat request (HARQ) processes and provide an indication to the serving cell that comprises a desired maximum number of uplink hybrid automatic repeat request (HARQ) processes based on an energy level of the apparatus. The apparatus may also be caused to perform downlink control information (DCI) monitoring for downlink or uplink until the maximum number of hybrid automatic repeat request (HARQ) processes is reached. The downlink control information (DCI) monitoring may be suspended when a corresponding maximum number of downlink or uplink hybrid automatic repeat request (HARQ) processes is exceeded.

Some exemplary embodiments may provide a non-transitory computer readable medium comprising program instructions. The program instructions, when executed by an apparatus, may cause the apparatus at least to determine that a user device with an unreliable power source based on an indication received from the user device, and reconfigure a maximum number of hybrid automatic repeat request (HARQ) processes and instruct the user device to operate in a half-duplex operation mode. The apparatus may also be caused to perform downlink control information (DCI) monitoring for downlink and/or uplink until the maximum number of hybrid automatic repeat request (HARQ) processes is reached. The downlink control information (DCI) monitoring may be suspended when a corresponding maximum number of downlink or uplink hybrid automatic repeat request (HARQ) processes is exceeded.

Certain exemplary embodiments may provide one or more computer programs including instructions stored thereon for performing one or more of the methods described herein. Some exemplary embodiments may also provide one or more apparatuses including one or more circuitry configured to perform one or more of the methods described herein.

### BRIEF DESCRIPTION OF THE DRAWINGS

For proper understanding of example embodiments, reference should be made to the accompanying drawings, as follows:

FIG. 1A illustrates an example of a radio resource control (RRC) segmentation using downlink (DL) packet data convergence protocol (PDCP);

FIG. 1B illustrates an exemplary chart of RRC processing times;

FIG. 2 illustrates an example of cumulative energy costs for a device during an RRC procedure operating in frequency division duplex (FDD) full duplex mode;

FIG. 3 illustrates an exemplary diagram showing results of a comparison of an FDD operating mode device to a higher layer half-duplex (HD) FDD operating mode device, according to various exemplary embodiments;

FIG. 4 illustrates an exemplary diagram showing relative energy costs of the comparison shown in FIG. 3, according to certain exemplary embodiments;

FIG. 5 illustrates an exemplary flowchart of one or more procedures performed by an energy harvest device (EHD), according to various exemplary embodiments;

FIG. 6 illustrates an exemplary flowchart of one or more procedures performed by a serving cell, according to various exemplary embodiments;

FIG. 7 illustrates an exemplary flow diagram of one or more procedures for layer 2 (L2) operations in DL and uplink (UL) between an EHD and a serving cell, according to various exemplary embodiments;

FIG. 8 illustrates an exemplary flow diagram of one or more procedures for layer 1 (L1) UL operations between an EHD and a serving cell, according to various exemplary embodiments;

FIG. 9 illustrates an exemplary flow diagram of one or more procedures for L1 DL operations between an EHD and a serving cell, according to various exemplary embodiments;

FIG. 10 illustrates an exemplary flow diagram of one or more procedures for activating an HD-FDD operation between an EHD and a serving cell, according to various exemplary embodiments;

FIG. 11 illustrates an example of a flow diagram of a method, according to

various exemplary embodiments;

FIG. 12 illustrates an example of a flow diagram of another method, according to various exemplary embodiments; and

FIG. 13 illustrates a set of apparatuses, according to various exemplary embodiments.

### DETAILED DESCRIPTION

It will be readily understood that the components of certain example embodiments, as generally described and illustrated in the figures herein, may be arranged and designed in a wide variety of different configurations. The following is a detailed description of some exemplary embodiments of systems, methods, apparatuses, and non-transitory computer program products for higher layer half duplex operation. Although the devices discussed below and shown in the figures refer to 5G or Next Generation NodeB (gNB) devices and user equipment (UE) devices, this disclosure is not limited to only gNBs and UEs. For example, the following description may also apply to any type of network access node or network device.

It may be readily understood that the components of certain example embodiments, as generally described and illustrated in the figures herein, may be arranged and designed in a wide variety of different configurations. Different reference designations from multiple figures may be used out of sequence in the description, to refer to a same element to illustrate their features or functions. If desired, the different functions or procedures discussed herein may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

In 5G/NR technology, narrowband internet of things (NB-IoT), enhanced machine type communication (eMTC), and NR reduced capability (RedCap) devices have been developed to provide low cost and low power devices for wide area IoT communications. The number of IoT connections has been growing rapidly in recent years. As the number of interconnections increases, there is a need for reducing the size, cost, and power consumption for IoT devices. In particular, regular/routine replacement of a battery for all the IoT devices will be impractical due to the tremendous consumption of materials and manpower.

Radio frequency identification (RFID) implementations have been used with backscattering technology, which allows wireless devices and/or nodes to communicate without requiring any active radiofrequency (RF) components. A goal of passive or ambient IoT is to use 3^{rd} Generation Partnership Project (3GPP) technology to enhance coverage for backscattering RFID implementations and more efficient use of energy for IoT-type data transmissions. Further, another goal for sustainability may be to achieve or get close to zero-energy communications. Zero-energy communications refers to user devices that operate without batteries and have energy harvesting capabilities, such as storing energy in a capacitor, or devices without batteries and no capability of storing energy.

The use of energy harvesting may be a useful solution by harvesting power from environments surrounding IoT devices to power the IoT devices for self-sustainable communications, especially in applications with a significant number of devices (e.g., ID tags and sensors). IoT devices using energy harvesting may be referred to as energy harvesting devices (EHD). EHD may have limited power storage and processing capabilities since these devices are targeted to be cost efficient.

Processing capabilities of an EHD may be more limited than NB-IoT or eMTC or RedCap devices. For example, when a node sends large packets or radio resource control (RRC) messages to a device, the packets may be segmented if the encoded message exceed the maximum allowed packet data convergence protocol (PDCP) protocol data unit (PDU) size. As another example, segmentation may occur at the radio link control (RLC) level based on radio conditions of the EHD and the serving nodes available resources of the EHD.

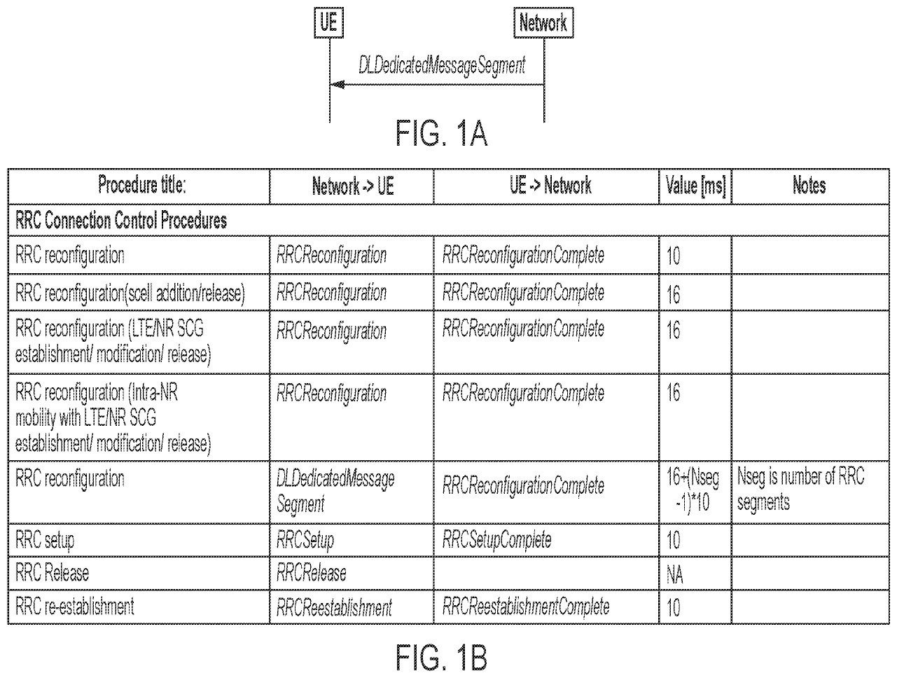

FIGS. 1A and 1B illustrate examples of RRC segmentation and RRC processing times. The processing of each segment sent to the EHD may have an associated power cost. The EHD may have limited processing capabilities overall, which may be accounted for when resources are allocated for EHDs. Certain RRC messages may be allowed longer processing times of, for example, up to 16 ms. EHDs and similar devices with reduced processing capabilities may require relaxation of the processing times to, for example, approximately 32 ms. EHDs may have limited ability to store energy and longer and more relaxed processing times may ensure that any communications or transactions with the network are handled to optimize the harvested energy by the EHD.

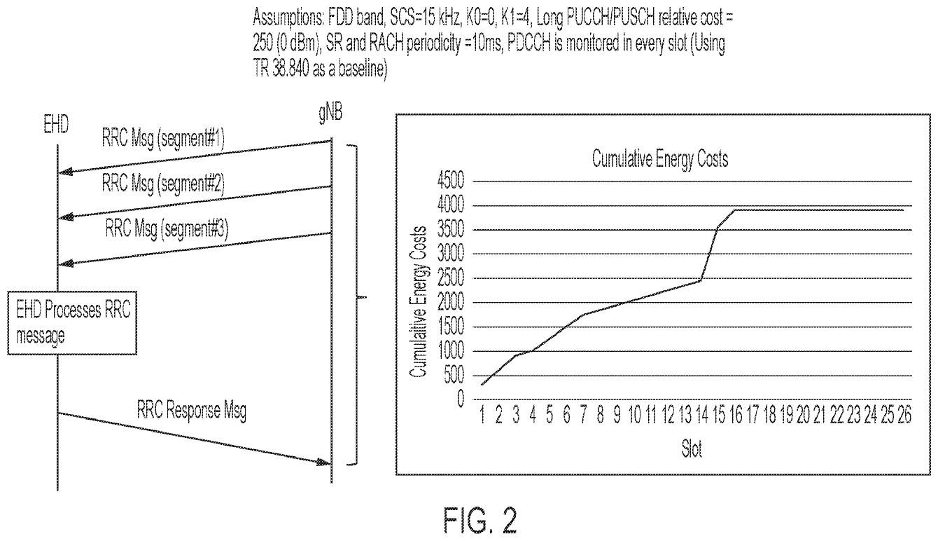

FIG. 2 illustrates an example of the cumulative energy costs for a device during an RRC procedure for a UE operating in frequency division duplex (FDD) full duplex mode. The exemplary UE in FIG. 2 may be expected to be able to transmit and receive simultaneously which could easily drain power resources when the UE is an EHD. It may be desirable for at least some information of the EHD (or gNB) to be transferred successfully over an air interface with the limited power resources. If power of the EHD is depleted, it could lead to dropped calls or radio link failure (RLF) and the need for a registration area update procedure. There would be no assurance that upon return to the network after the RLF, the EHD could complete any remaining transactions appropriately.

To aid in power savings, it has been proposed to operate a UE in a half duplex frequency division duplex (HD-FDD) operation mode. However, the HD-FDD operation mode is only from Layer 1 perspective and there is no coordination with Layer 2.

Various exemplary embodiments may provide advantages to resolve issues in the technology. For example, certain exemplary embodiments may advantageously provide one or more procedures to provide coordination between Layer 1 and Layer 2 when the UE is in HD-FDD or half-duplex operation mode, which may provide larger power savings because the UE may spend less time monitoring the control channel. Certain exemplary embodiments may allow for buffering L2 PDUs for UL or DL at a given moment, so L2 buffering requirements may be further relaxed.

Physical downlink control channel (PDCCH) monitoring may be performed until the slot before a UE/EHD receives a scheduled physical downlink shared channel (PDSCH). However, to improve and increase energy efficiency, some exemplary embodiments may limit the number of hybrid automatic repeat request (HARQ) processes and the periods in which an EHD is required to monitor a PDCCH may be bounded by when the EHD/UE is scheduled to send UL feedback for a corresponding HARQ process. A reconfiguration of the number of HARQ processes may differ for UL and DL. Certain exemplary embodiments may configure UL HARQ resources based on a memory and/or buffering capacity of a UE/EHD and may dynamically modify the UL HARQ processes of the UE/EHD based on the stored and/or harvested power levels of the UE/EHD.

When an energy harvesting scenario or the power levels of the UE/EHD change, the EHD may transmit in the UL to inform the network of this change. However, UL transmissions may require a high level of energy consumption. Thus, various exemplary embodiments may minimize the UL overhead for improved energy efficient use of the resources of the UE/EHD.

Some exemplary embodiments may refer to UE-type devices, which may include, but is not limited to, a UE, EHD, RedCap UE, mobile equipment (ME), mobile device, IoT device, or other similar device which may have reduced processing capabilities and/or reduced battery size. For exemplary purposes only, the descriptions herein may refer to an EHD, but any UE-type device may also be used.

Various exemplary embodiments may provide one or more procedures for a UE, such as an EHD, to operate in a higher layer HD-FDD operation mode depending on the EHD's capabilities to enable increased energy savings and may allow the EHD to employ its energy resources more efficiently. The one or more procedures may include a gNB that detects that an EHD has entered a discontinuous transmission (DTX) mode by, for example, detecting that the EHD may be unresponsive to allocations or the EHD may continuously fail during RRC procedures, or the gNB may be informed by the EHD that it has an unreliable or inconsistent power source.

In some exemplary embodiments, the gNB may schedule the EHD to operate in the HD-FDD operation mode at the PDCP or RLC level. The gNB may schedule either a DL PDCP (or RLC) or an UL PDCP (or RLC) for the EHD at a particular time so that the EHD is not transmitting and receiving simultaneously. The gNB may select the number of HARQ processes of the EHD based on one or more criterion, such as an energy level of the EHD or energy arrival at the EHD. The number of HARQ processes may be configured for the EHD by, for example, downlink control information (DCI) or medium access control (MAC). A reduced number of HARQ processes may improve the power requirements.

The EHD may request a desired number of the UL HARQ processes based on its energy storage levels. The number of HARQ processes may be the same or different for UL as compared to DL. The EHD may simplify DCI monitoring procedures by the EHD in a user search space when the gNB does not allocate resources for simultaneous UL and DL data processing at the EHD. After gNB has transmitted a PDSCH for each of the HARQ processes according to the set number of HARQ processes, the gNB may not schedule the EHD until the gNB receives physical uplink control channel (PUCCH) feedback which allows the EHD to not have to monitor the PDCCH during a time period in which PDCCH transmission from the gNB and the monitoring by the EHD is suspended.

Various exemplary embodiments may provide that after transmission of the PDCP (or RLC) PDU is completed, the gNB may allow or set an amount of processing time by not scheduling the PDCCH for the EHD during this period. For the RRC, the processing time may be set or established and for user plane data, the processing time may be based on a capability of the EHD and/or based on the PDU size. The EHD may reduce or eliminate wasting of energy resources for monitoring the PDCCH, until the associated processing time timer expires. For example, a Layer 2 (L2) of the EHD detects the PDCP (or RLC) PDU has been fully transmitted or received, the L2 of the EHD will suspend PDCCH monitoring for a certain amount of time via an indication to from the L2 to the Layer 1 (L1) of the EHD.

The various exemplary embodiments may provide for more reliable transmissions with smaller spikes or sudden increases of energy throughout a data transfer process. Certain exemplary embodiments may allow for the EHD to avoid depleting its energy resources prior to completing its prescribed data transfer with the network, which may lead to RLF and re-establishment procedures which do not improve the overall spectral efficiency.

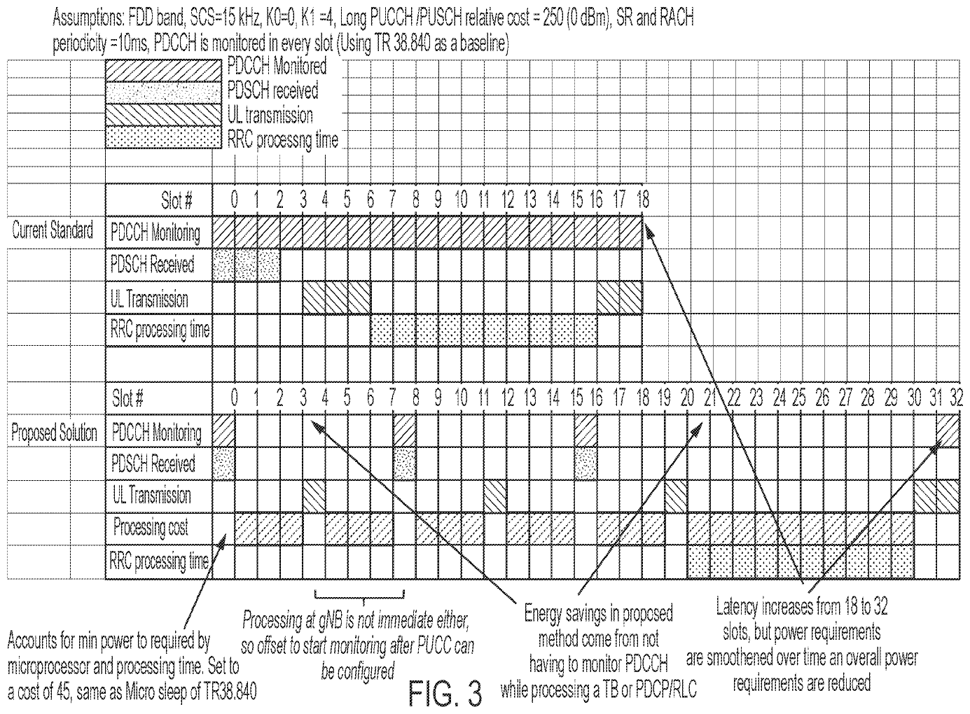

FIG. 3 illustrates an exemplary diagram showing results of a comparison of a known higher layer FDD operating mode to a higher layer HD-FDD operating mode, according to various exemplary embodiments. As shown in FIG. 3, the higher layer HD-FDD operating mode according to various exemplary embodiments may reduce the overall PDCCH monitoring time and may avoid UL and DL transmissions occurring at the same time, even if there is a potential increase in latency. Energy savings may be achieved by not monitoring the PDCCH while processing a transport block (TB) or a PDCP/RLC.

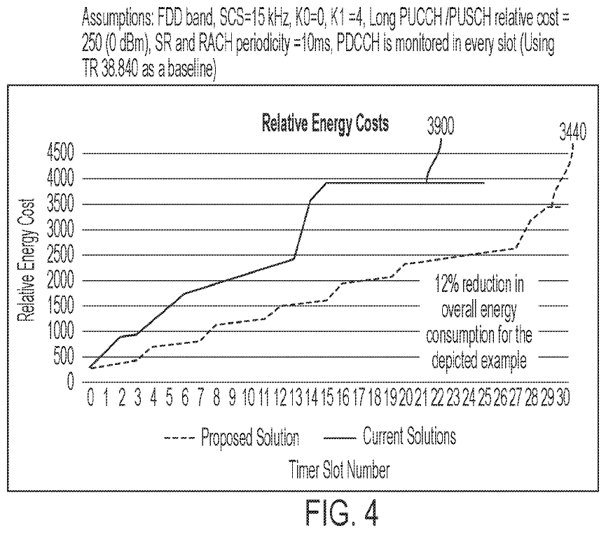

FIG. 4 illustrates an exemplary diagram showing relative energy costs of the comparison shown in FIG. 3, according to certain exemplary embodiments. FIG. 4 shows the comparison of the relative energy costs of the known FDD operating mode and a higher layer HD-FDD operating mode according to various exemplary embodiments. The various exemplary embodiments may provide an overall reduction in the energy costs. The comparison may be based on certain conditions that apply to both, such as operating in the FDD band, subcarrier spacing (SCS)=15 kHz, K0=0, K1=4, PUCCH/PUSCH relative cost=250 (0 dBm), scheduling request and RACH periodicity=10 ms, and PDCCH is monitored in every slot. K0 may be defined as the PDSCH time allocation, which may indicate when to expect the PDSCH in relation to the DCI with the DL allocation, and K1 may be defined as the PDSCH acknowledgement/non-acknowledgment (Ack/NAck) timing, such as when the feedback for the PDSCH has to be sent in the UL.

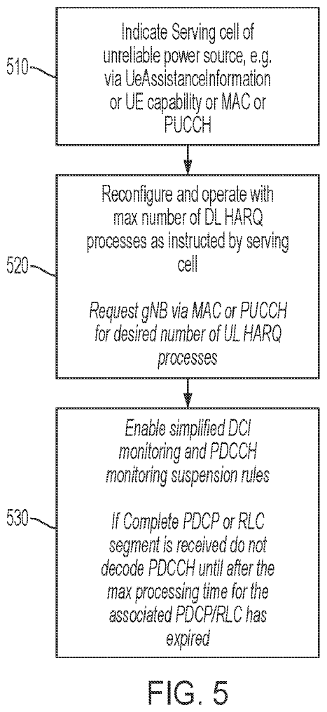

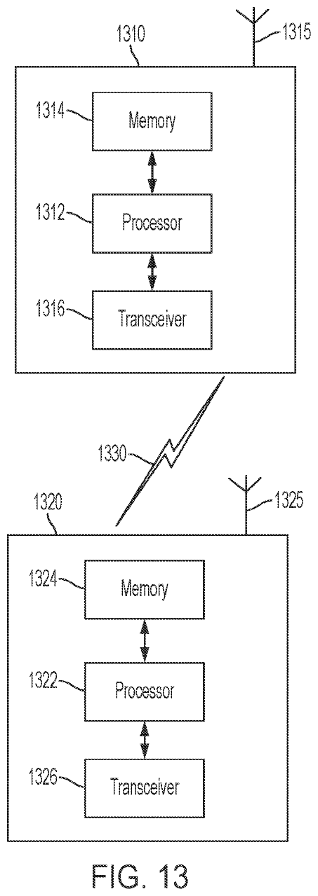

FIG. 5 illustrates an exemplary flowchart of one or more procedures performed by an EHD (similar to EHD 701/801/901/1001 and apparatus 1310 of FIG. 13), according to various exemplary embodiments. At 510, the EHD may indicate to a serving cell, such as a gNB (similar to serving cell 702/802/902/1002 and apparatus 1320 of FIG. 13), that the EHD has an unreliable or inconsistent or intermittent power source. For example, the EHD may use UEAssistanceInformation procedure to indicate that the EHD has an unreliable power source and employ a MAC Control Element and/or an indication via PUCCH.

At 520, the EHD may reconfigure a maximum number of DL HARQ processes as instructed by the serving cell and operate according to the configured by of DL HARQ processes. The EHD may send a request to the serving cell for a desired number of UL HARQ processes using a MAC and/or a PUCCH. The EHD may inform the serving cell (e.g., gNB) to reconfigure the maximum number of HARQ processes based on its energy harvesting capability. This may allow the EHD to harvest more energy between UL transmissions. The EHD may employ MAC or UL control information (UCI) to inform to, or request from, the serving cell of the desired number of UL HARQ processes. The gNB may confirm to the EHD that this request for a desired number of UL HARQ processes has been accepted.

At 530, the EHD may enable a simplified DCI monitoring process and may enable PDCCH monitoring suspension rules, which may set when the PDCCH monitoring may occur or may be suspended. If the complete PDCP or RLC segment is received, the EHD may not decode the PDCCH until after a maximum processing time for the associated PDCP/RLC has elapsed/expired. The EHD that may be operating in the higher layer HD-FDD operation mode may perform certain procedures, such as when the EHD detects a DL DCI, the EHD may monitor for DL DCIs in the user search space until the maximum number of DL HARQ processes is reached. Once the EHD detects a UL DCI, the EHD may monitor for UL DCIs in the user search space until the maximum number of UL HARQ processes is reached. Upon resuming PDCCH monitoring after a suspension of PDCCH monitoring, the EHD may monitor both UL and DL DCIs. Alternately, a number of blind decoding may be reduced for each monitoring of the user search space.

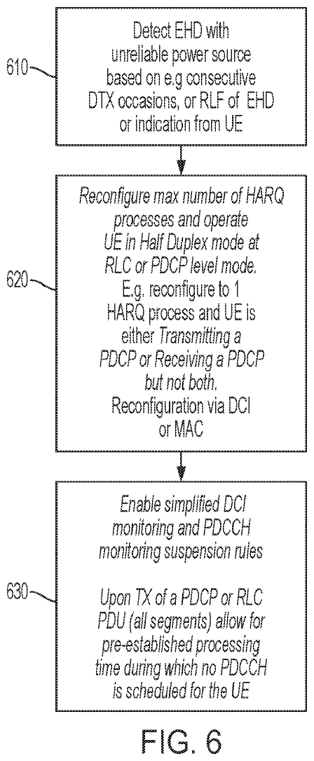

FIG. 6 illustrates an exemplary flowchart of one or more procedures performed by a serving cell, such as a gNB (similar to serving cell 702/802/902/1002 and apparatus 1320 of FIG. 13), according to various exemplary embodiments. At 610, gNB may detect an EHD (similar to EHD 701/801/901/1001 and apparatus 1310 of FIG. 13) with an unreliable or inconsistent or intermittent power source. The gNB may detect the unreliable power source of the EHD based on, for example, DTX occasions, RLF of the EHD, or an indication received from the EHD.

At 620, the gNB may reconfigure a maximum or set number of HARQ processes and instruct the EHD to operate in a HD-FDD operation mode at an RLF or PDCP. As a non-limiting example, the gNB may reconfigure the EHD to have a maximum of one (1) HARQ process and the EHD may either transmit a PDCP or receive a PDCP. The reconfiguration by the gNB may be performed using a DCI or MAC. At 630, the gNB may enable a simplified DCI monitoring process and may enable PDCCH monitoring suspension rules, which may be set when the PDCCH monitoring may occur or may be suspended. Upon transmitting the PDCP or RLC PDU, the gNB may allow for a pre-established processing time in which no PDCCH is scheduled for the EHD.

Some exemplary embodiments may provide that PDCCH monitoring may be suspended or stopped for a period of time. The start of this suspension period of time may be when the EHD has received PDCCH grants for the maximum number of UL or DL HARQ processes configured for the EHD. The stop of the suspension period of time for PDCCH monitoring may depend on multiple factors, such as two factors, and PDCCH monitoring may be allowed when the two factors indicate the allowance of PDCCH monitoring. The two factors may be L1 criteria based upon if UL or DL was scheduled and L2 criteria based on receiving a complete PDCP or RLC PDU.

L1 criteria may be such that the stop of the suspension for monitoring the PDCCH when DL grants have been received may be when the PUCCH feedback corresponding to the scheduled PDSCH has been transmitted. A pre-configured offset may be configured to extend this suspension time and allow for some harvesting after the PUCCH UL transmission. L1 criteria may also be for the stop of the suspension for monitoring the PDCCH when UL grants have been received may be based on a configured timer. Upon transmission of PUSCH, the EHD may start the configured timer. When the configured timer expires, the EHD may resume PDCCH monitoring. An initial value of the configured timer may be, for example, provided semi-statically to the EHD and an incremental delay may be provided using UL DCIs.

L2 criteria may provide the EHD with a processing time period after receiving a complete PDCP or RLC PDU for C-plane or U-plane. When L2 of the EHD detects PDCP (or RLC) PDU has been fully transmitted or received, the EHD may suspend PDCCH monitoring for a certain amount of time via an indication from L2 to L1 of the EHD. During a UL scenario, the EHD may not be aware of when the PDCP (or RLC) PDU is received correctly at the serving node/gNB and a timer may be applied by the EHD. During the processing time period, the EHD may not monitor the PDCCH. The value for the processing time may be provided to the EHD semi-statically or defined in pre-determined specifications, such as 3GPP specifications. During DL scenarios, the serving cell/gNB may become aware of when the EHD has received the complete PDCP (or RLC) PDU based on an RLC acknowledgement message (ACK) or the serving node/gNB may employ a timer which may establish a waiting period after the last segment of the PDU is transmitted. A serving cell/gNB scheduler may prioritize UL or DL PDCP (or RLC) resource allocation based on a priority associated with the PDU. In the DL scenario, the priority may be provided by the higher layers of the serving cell/gNB, and for the UL scenario, the serving cell/gNB scheduler may derive the priority based on, for example, an EHD logical channel identifier (ID) used in a buffer status report (BSR) or a scheduling request (SR) occasion employed by the EHD.

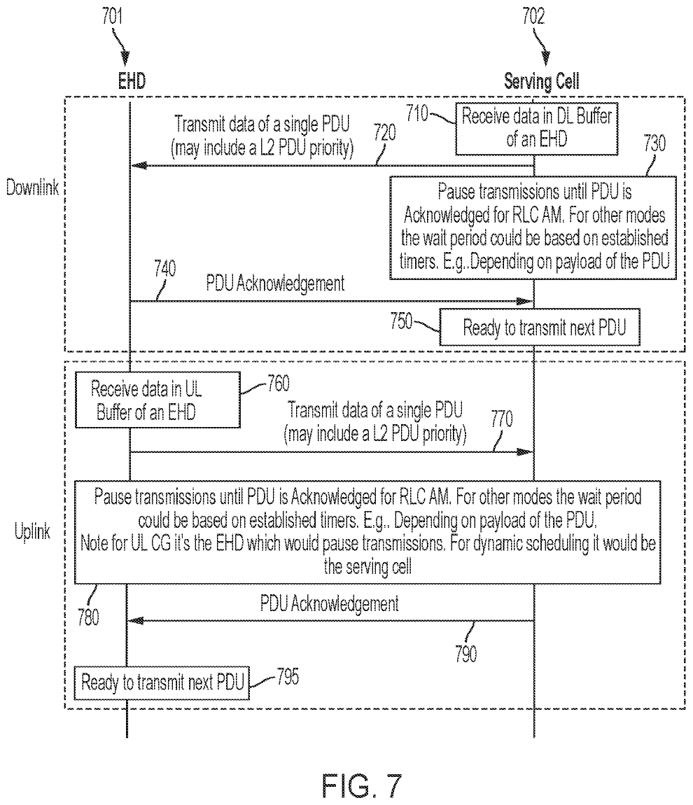

FIG. 7 illustrates an exemplary flow diagram of one or more procedures for L2 operations in DL and UL between an EHD 701 (similar to EHD 801/901/1001 and apparatus 1310 of FIG. 13) and a serving cell 702 (similar to serving cell 802/902/1002 and apparatus 1320 of FIG. 13), such as a gNB, according to various exemplary embodiments. At 710, the serving cell may receive data in a DL buffer of the EHD. At 720, the serving cell may transmit, to the EHD, data of a single PDU, which may include an L2 PDU priority.

At 730, the serving cell may pause or suspend transmissions for a time/wait period until the PDU is acknowledged for an RLC acknowledge mode (AM). For other modes, wait period may be based on an established timer, which may, for example, be based on a payload of the PDU. At 740, the EHD may transmit a PDU acknowledgement to the serving cell. At 750, the serving cell may be configured to be ready to transmit a next PDU. As shown in FIG. 7, operations 710-750 may be performed during a DL.

At 760, which is performed during the UL, the EHD may receive data in a UL buffer of the EHD. At 770, the EHD may transmit data of a single PDU to the serving cell, which may include L2 PDU priority. At 780, one of the serving cell or the EHD may pause or suspend transmissions for a time/wait period until the PDU is acknowledged for an RLC AM. For other modes, the wait period may be based on an established timer, which may, for example, be based on a payload of the PDU. The EHD may perform the pause or suspension of transmissions when the UL transmission is a configured grant (CG) UL. The serving cell may perform the pause or suspension of transmissions when dynamic scheduling is used for the UL. At 790, the serving cell provides a PDU acknowledgement to the EHD. At 795, the EHD may be ready to transmit a next PDU.

The serving cell (e.g., gNB) may control the allocation of resources and may ensure that the EHD is not scheduled to transmit a PDCP (or RLC) PDU if the EHD is in the process of receiving a PDU/RLC. This may simplify the processing requirements for the EHD and may enable a half-duplex operation at a higher layer.

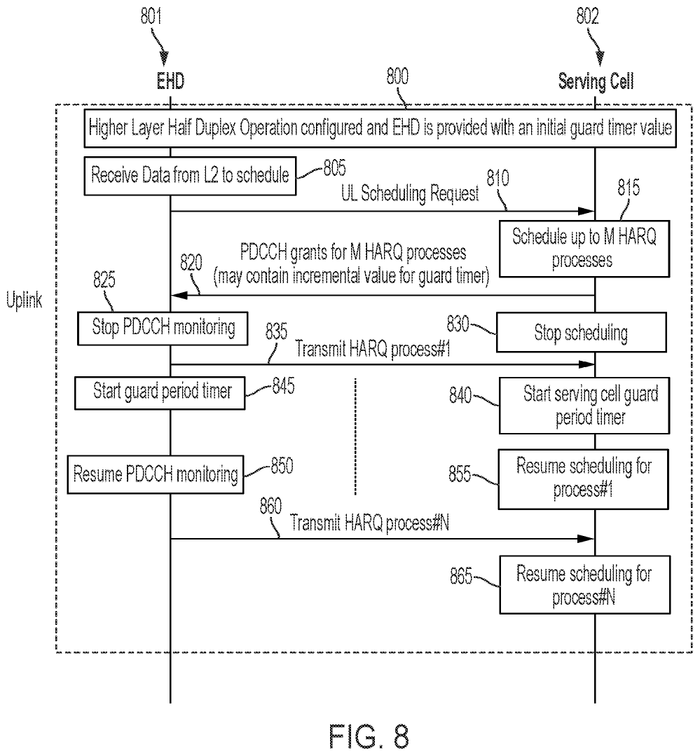

FIG. 8 illustrates an exemplary flow diagram of one or more procedures for L1 UL operations between an EHD 801 (similar to EHD 701/901/1001 and apparatus 1310 of FIG. 13) and a serving cell 802 (similar to serving cell 702/802/902/1002 and apparatus 1320 of FIG. 13), such as a gNB, according to various exemplary embodiments. At 800, the EHD and the serving cell may be configured for higher layer HD-FDD operation and the EHD is provided with an initial guard timer value. At 805, the EHD may receive data from L2 to schedule. At 810, the EHD may transit a UL scheduling request to the serving cell. At 815, the serving cell may schedule up to a number M HARQ processes.

At 820, the serving cell may transmit one or more PDCCH grants for the M HARQ processes. The PDCCH grant(s) may include an incremental value for the guard timer. At 825, the EHD may stop PDCCH monitoring, and at 830, the serving cell may stop scheduling HARQ processes. At 835, the EHD may transmit a HARQ process #1 to the serving cell. At 840, the serving cell may start the serving cell guard period timer, and at 845, the EHD may start a guard period timer.

At 850, the EHD may resume PDCCH scheduling, and at 855, the serving cell may resume scheduling for the HARQ process #1. At 860, the EHD may transmit a HARQ process #N, and at 865, the serving cell may resume scheduling for process #N.

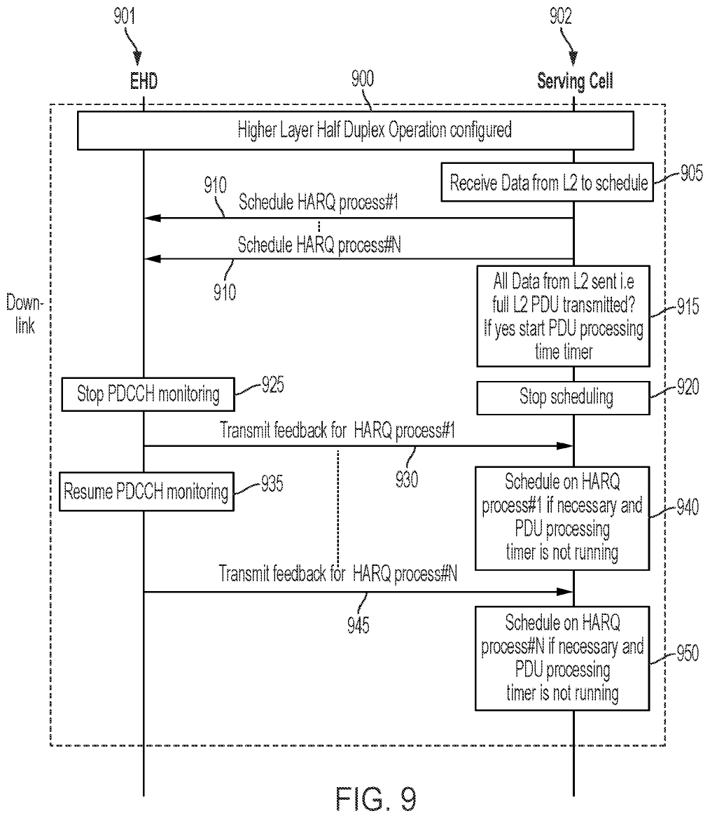

FIG. 9 illustrates an exemplary flow diagram of one or more procedures for L1 DL operations between an EHD 901 (similar to EHD 701/801/1001 and apparatus 1310 of FIG. 13) and a serving cell 902 (similar to serving cell 702/802/1002 and apparatus 1320 of FIG. 13), such as a gNB, according to various exemplary embodiments. At 900, the EHD and the serving cell may be configured for higher layer HD-FDD operation. At 905, the serving cell may receive data from L2 to schedule. At 910, the serving cell may schedule and transit, to the EHD, a number M HARQ processes, such as HARQ #1 to HARQ #N.

At 915, the serving cell may determine whether all of the data from L2 has been sent such that the complete L2 PDU may be transmitted. The serving cell may start a PDU processing time timer when the complete L2 PDU has been transmitted. At 920, the serving cell may stop scheduling, and at 925, the EHD may stop PDCCH monitoring. At 930, the EHD may transmit to the serving cell feedback from the HARQ process #1.

At 935, the EHD may resume PDCCH monitoring, and at 940, the serving cell may schedule on HARQ process #1 when needed and the PDU processing timer is not running and/or has expired. At 945, the EHD may transmit feedback for a HARQ process #N, and at 950, the serving cell may schedule on HARQ process #N when needed and the PDU processing timer is not running and/or has expired.

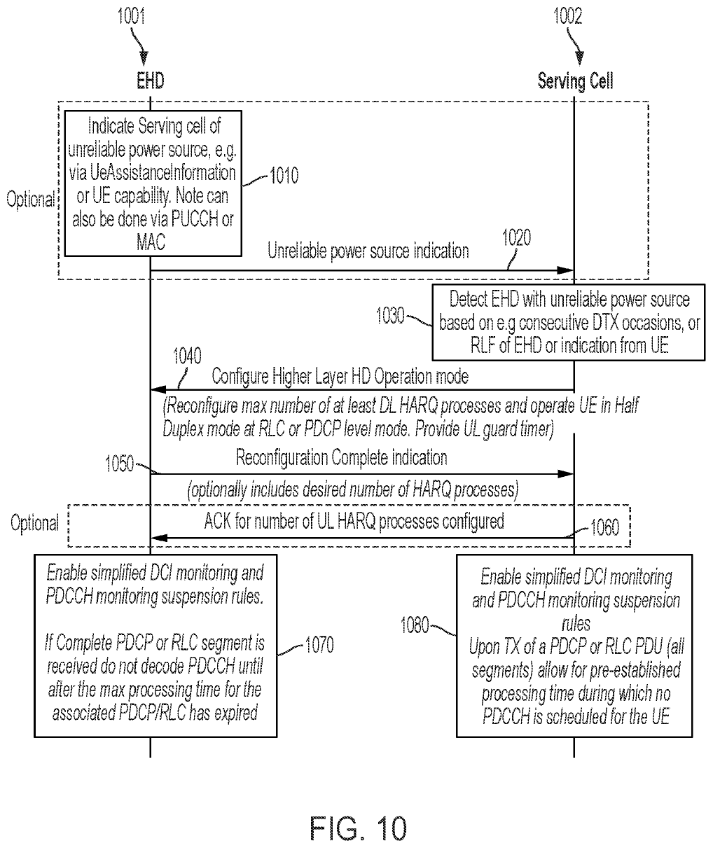

FIG. 10 illustrates an exemplary flow diagram of one or more procedures for activating an HD-FDD operation between an EHD 1001 (similar to EHD 701/801/901 and apparatus 1310 of FIG. 13) and a serving cell 1002 (similar to serving cell 702/802/902/1002 and apparatus 1320 of FIG. 13), such as a gNB, according to various exemplary embodiments. At 1010, the EHD may indicate the serving cell of an unreliable or inconsistent or intermittent power source. For example, the EHD may use an UEAssistanceInformation procedure to inform the serving cell of an unreliable power source during a capability exchange of the EHD, via a MAC Control Element and/or an indication via a PUCCH.

At 1020, the EHD may provide an indication of the unreliable power source to the serving cell. At 1030, the serving cell may detect the EHD with the unreliable power source based on, for example, consecutive DTX occasions, RLF of the EHD, or the indication from the EHD. At 1040, the serving cell may configure and transmit, to the EHD, a higher layer HD-FDD operation mode. This may be performed by, for example, reconfiguring a maximum number of at least DL HARQ processes and operate the EHD in the HD-FDD mode at the RLC or PDCP level mode. The serving cell also provides a UL guard timer.

At 1050, the EHD may provide a reconfiguration complete indication to the serving cell. The reconfiguration complete indication may include a desired number of HARQ processes. At 1060, the serving cell may provide, to the EHD, an ACK for a number of UL HARQ processes configured for the EHD. At 1070, the EHD may enable a simplified DCI monitoring process and may enable PDCCH monitoring suspension rules. The PDCCH monitoring suspension rules may determine whether the PDCCH monitoring may occur or may be suspended. If the complete PDCP or RLC segment is received, the EHD may not decode the PDCCH until after a maximum processing time for the associated PDCP/RLC has elapsed/expired. At 1080, the gNB may enable a simplified DCI monitoring process and may enable PDCCH monitoring suspension rules, which may be set when the PDCCH monitoring may occur or may be suspended. Upon transmitting the PDCP or RLC PDU, the gNB may allow for a pre-established processing time in which no PDCCH is scheduled for the EHD.

In various exemplary embodiments, triggering the activation of the HD-FDD operation mode may be based on the serving cell/gNB detecting the unreliable transmissions from an EHD. Detecting the unreliable transmissions from the EHD may be based on, for example, DTX detection or a cycle of RLF or an explicit indication from the EHD. The configuration of the higher layer HD-FDD operation mode, as shown in FIG. 10, may be performed via DCI or MAC to allow for less computational complexity and overheads of higher layer.

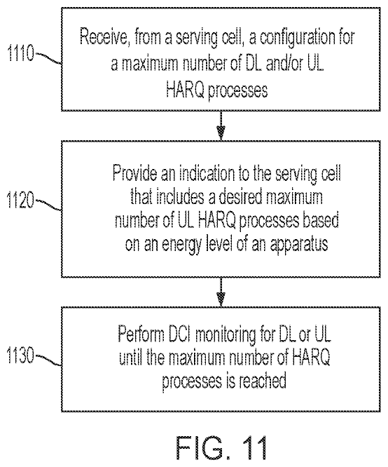

FIG. 11 illustrates an example flow diagram of a method, according to certain exemplary embodiments. In an example embodiment, the method of FIG. 11 may be performed by a network element, or a group of multiple network elements in a 3GPP system, such as LTE or 5G-NR. For instance, in an exemplary embodiment, the method of FIG. 11 may be performed by a mobile network device or user device, such as an EHD, similar to EHD 701/801/901/1001 and apparatus 1310 of FIG. 13.

According to various exemplary embodiments, the method of FIG. 11 may include, at 1110, receiving, by the apparatus 1310/EHD (similar to EHD 701/801/901/1001 and apparatus 1310 of FIG. 13) from a serving cell (similar to serving cell 702/802/902/1002 and apparatus 1320 of FIG. 13), a configuration for a maximum number of downlink and/or uplink hybrid automatic repeat request (HARQ) processes. At 1120, the method may further include providing an indication to the serving cell (similar to serving cell 702/802/902/1002 and apparatus 1320 of FIG. 13) that may include a desired maximum number of uplink hybrid automatic repeat request (HARQ) processes based on an energy level of the apparatus 1310/EHD (similar to EHD 701/801/901/1001). The method may also include, at 1130, performing downlink control information (DCI) monitoring for downlink or uplink until the maximum number of hybrid automatic repeat request (HARQ) processes is reached. The downlink control information (DCI) monitoring may be suspended when a corresponding maximum number of downlink or uplink hybrid automatic repeat request (HARQ) processes is exceeded.

According to various exemplary embodiments, the method may also include, when the DCI for downlink is detected, monitoring a search space until a maximum configured DL HARQ processes is reached. The method may further include when the DCI for uplink is detected, monitoring the search space until the maximum configured UL HARQ processes is reached.

Some exemplary embodiments may provide that the downlink control information (DCI) monitoring may be suspended for downlink and/or uplink when one of uplink layer 2 data is being transmitted or downlink layer 2 data is being received.

Certain exemplary embodiments may provide that the suspension of performing the DCI monitoring is ended and monitoring is resumed after a processing time when a complete packet data convergence protocol (PDCP) or radio link control (RLC) segment is received by the apparatus (similar to EHD 701/801/901/1001 and apparatus 1310 of FIG. 13).

In some exemplary embodiments, the complete packet data convergence protocol (PDCP) or the radio link control (RLC) segment may be for control plane and/or user plane (U-plane). The processing time may be defined or configured for control plane and may be determined for U-plane. The processing time determined for the U-plane may be determined based on a transport block size or service data unit size.

Various exemplary embodiments may provide processing and transmitting or receiving of a complete packet data convergence protocol (PDCP) or radio link control (RLC) segment are sequential. When performing the DCI monitoring for downlink, the suspension of performing the monitoring may be ended based on transmitting uplink channel feedback corresponding to a scheduled downlink shared channel. When performing the DCI monitoring for uplink, the suspension of performing the monitoring may be ended based on a configured timer.

Certain exemplary embodiments may provide an initial value of the configured timer may be set and provided to the apparatus/EHD (similar to EHD 701/801/901/1001 and apparatus 1310 of FIG. 13) by the serving cell (similar to serving cell 702/802/902/1002 and apparatus 1320 of FIG. 13). The initial value may be incrementally increased by an indication in the DCI for uplink.

Various exemplary embodiments may provide that the method also includes indicating to the serving cell (similar to serving cell 702/802/902/1002 and apparatus 1320 of FIG. 13) that the apparatus/EHD (similar to EHD 701/801/901/1001 and apparatus 1310 of FIG. 13) has an unreliable power source.

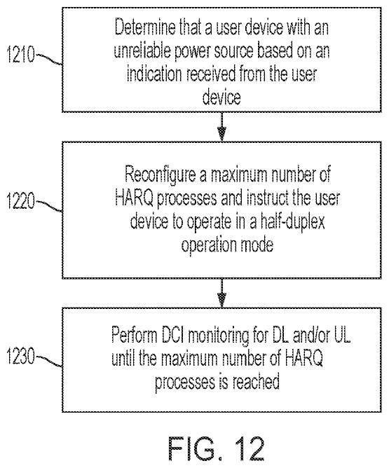

FIG. 12 illustrates an example flow diagram of a method, according to certain exemplary embodiments. In an example embodiment, the method of FIG. 12 may be performed by a network element, or a group of multiple network elements in a 3GPP system, such as LTE or 5G-NR. For instance, in an exemplary embodiment, the method of FIG. 12 may be performed by a network device or network entity, such as a base station, serving cell, or gNB, similar to apparatus 1320 and the serving cell 702/802/902/1002.

According to various exemplary embodiments, the method of FIG. 12 may include, at 1210, determining that a user device (similar to EHD 701/801/901/1001; apparatus/EHD of FIG. 11; and apparatus 1310 of FIG. 13) with an unreliable power source based on an indication received from the user device (similar to EHD 701/801/901/1001; apparatus/EHD of FIG. 11; and apparatus 1310 of FIG. 13). The method may also include, at 1220, reconfiguring a maximum number of HARQ processes, and instructing the user device (similar to EHD 701/801/901/1001; apparatus/EHD of FIG. 11; and apparatus 1310 of FIG. 13) to operate in a half-duplex operation mode. The method may further include, at 1230, performing DCI monitoring for DL and/or UL until the maximum number of HARQ processes is reached. The DCI monitoring may be suspended when a corresponding maximum number of DL or UL HARQ processes is exceeded.

Various exemplary embodiments may provide that the maximum number of HARQ processes may be reconfigured such that the user device (similar to EHD 701/801/901/1001; apparatus/EHD of FIG. 11; and apparatus 1310 of FIG. 13) operates to one of: (i) transmit a packet data convergence protocol (PDCP) or radio link control (RLC) segment or (ii) receive the packet data convergence protocol (PDCP) or radio link control (RLC) segment.

Some exemplary embodiments may provide the DCI monitoring may be suspended for DL when one of uplink layer 2 data is being transmitted or downlink layer 2 data is being received. The suspension of performing the DCI monitoring may be ended and monitoring may be resumed after a processing time when a complete packet data convergence protocol (PDCP) or radio link control (RLC) segment may be transmitted to the user device (similar to EHD 701/801/901/1001; apparatus/EHD of FIG. 11; and apparatus 1310 of FIG. 13). The complete packet data convergence protocol (PDCP) or the radio link control (RLC) segment may be for control plane and/or user plane. The processing time may be defined or configured for control plane and may be determined for U-plane. The processing time determined for the U-plane may be determined based on a transport block size or service data unit size.

Various exemplary embodiments may also provide processing and transmitting or receiving of a complete packet data convergence protocol (PDCP) or radio link control (RLC) segment may be sequential. When performing the DCI monitoring for DL and/or UL, the suspension of performing the monitoring may be ended based on transmitting uplink channel feedback corresponding to a scheduled downlink shared channel. When performing the DCI monitoring for UL, the suspension of performing the monitoring may be ended based on a configured timer.

Some exemplary embodiments may also provide that the method may further include setting and providing an initial value of the configured timer to the user device (similar to EHD 701/801/901/1001; apparatus/EHD of FIG. 11; and apparatus 1310 of FIG. 13). The initial value may be incrementally increased by an indication in the DCI for UL.

FIG. 13 illustrates a set of apparatuses 1310 and 1320 according to various exemplary embodiments. In the various exemplary embodiments, the apparatus 1310 may be may be an element in a communications network or associated with such a network, such as a UE, EHD, RedCap UE, SL UE, mobile equipment (ME), mobile station, mobile device, stationary device, IoT device, or other device. For example, the EHDs of FIGS. 5-10 according to various exemplary embodiments as discussed above may be examples of apparatus 1310. It should be noted that one of ordinary skill in the art would understand that apparatus 1310 may include components or features not shown in FIG. 13. In addition, apparatus 1320 may be a network, network entity, element of the core network, or element in a communications network or associated with such a network, such as a base station, serving node, an NE, or a gNB. For example, the serving node 702/802/902/1002 and gNB of FIGS. 7-10 according to various exemplary embodiments discussed above may be examples of apparatus 1320.

According to various exemplary embodiments, the apparatus 1310 may include at least one processor 1312, and at least one memory 1314, as shown in FIG. 13. The memory 1314 may store instructions that, when executed by the processor 1312, cause the apparatus 1310 to receive, from a serving cell (similar to serving cell 702/802/902/1002 and apparatus 1320 of FIG. 13), a configuration for a maximum number of downlink and/or uplink hybrid automatic repeat request (HARQ) processes, and provide an indication to the serving cell (similar to serving cell 702/802/902/1002 and apparatus 1320 of FIG. 13) that includes a desired maximum number of uplink HARQ processes based on an energy level of the apparatus 1310 (similar to EHD 701/801/901/1001). The apparatus 1310 may further be caused to perform DCI monitoring for DL or UL until the maximum number of HARQ processes may be reached. The DCI monitoring may be suspended when a corresponding maximum number of DL or UL HARQ processes is exceeded.

In some exemplary embodiments, when the downlink control information (DCI) for downlink is detected, the apparatus 1310 may be caused to monitor a search space until a maximum configured DL HARQ process(es) is reached. When the downlink control information (DCI) for uplink is detected, the apparatus 1310 may be caused to monitor the search space until the maximum configured UL HARQ process(es) is reached.

Certain exemplary embodiments may provide the DCI monitoring is suspended for DL and/or UL when one of uplink layer 2 data is being transmitted, or downlink layer 2 data is being received.

Some exemplary embodiments may provide that the suspension of performing the DCI monitoring may be ended and monitoring may be resumed after a processing time when a complete PDCP or RLC segment is received by the apparatus 1310. The complete PDCP or the RLC segment may be for control plane and/or user plane (U-plane). The processing time may be defined or configured for control plane and may be determined for user plane (U-plane). The processing time determined for the user plane (U-plane) may be determined based on a transport block size or service data unit size. According to various exemplary embodiments, processing and transmitting or receiving of a complete PDCP or RLC segment may be sequential.

Certain exemplary embodiments may provide that when performing the DCI monitoring for DL, the suspension of performing the monitoring may be ended based on transmitting UL channel feedback corresponding to a scheduled DL shared channel. When performing the DCI monitoring for UL, the suspension of performing the monitoring may be ended based on a configured timer. An initial value of the configured timer may be set and provided to the apparatus 1310 by the serving cell (apparatus 1320; similar to serving cell 702/802/902/1002). The initial value may be incrementally increased by an indication in the DCI for UL.

In some exemplary embodiments, the apparatus 1310 may be caused to indicate to the serving cell (apparatus 1320; similar to serving cell 702/802/902/1002) that the apparatus 1310 has an unreliable power source.

According to various exemplary embodiments, the apparatus 1320 (similar to serving cell 702/802/902/1002) may include at least one processor 1322, and at least one memory 1314, as shown in FIG. 13. The memory 1314 may store instructions that, when executed by the processor 1312, cause the apparatus 1320 (similar to serving cell 702/802/902/1002) to determine that a user device (similar to EHD 701/801/901/1001 and apparatus 1310 of FIG. 13) with an unreliable power source based on an indication received from the user device (similar to EHD 701/801/901/1001 and apparatus 1310 of FIG. 13). The apparatus 1320 (similar to serving cell 702/802/902/1002) may be further caused to reconfigure a maximum number of HARQ processes and instruct the user device (similar to EHD 701/801/901/1001 and apparatus 1310 of FIG. 13) to operate in a half-duplex operation mode. The apparatus 1320 (similar to serving cell 702/802/902/1002) may be also caused to perform DCI monitoring for DL and/or UL until the maximum number of HARQ processes may be reached. The DCI monitoring may be suspended when a corresponding maximum number of DL or UL HARQ processes may be exceeded.

Certain exemplary embodiments may provide that the maximum number of HARQ processes may be reconfigured such that the user device (similar to EHD 701/801/901/1001 and apparatus 1310 of FIG. 13) operates to one of: (i) transmit a PDCP or RLC segment or (ii) receive the PDCP or RLC segment. The DCI monitoring may be suspended for DL and/or UL when one of uplink layer 2 data is being transmitted or downlink layer 2 data is being received.

Various exemplary embodiments may provide that the suspension of performing the DCI monitoring may be ended and the monitoring may be resumed, after a processing time when a complete PDCP or RLC segment is transmitted to the user device (similar to EHD 701/801/901/1001 and apparatus 1310 of FIG. 13). The complete PDCP or the RLC segment may be for control plane and/or user plane (U-plane). The processing time may be defined or configured for control plane and may be determined for user plane (U-plane). The processing time determined for the user plane (U-plane) may be determined based on a transport block size or service data unit size. Some exemplary embodiments may provide that processing and transmitting or receiving of a complete PDCP or RLC segment may be sequential.

Certain exemplary embodiments may provide that when performing the DCI monitoring for DL, the suspension of performing the monitoring may be ended based on transmitting UL channel feedback corresponding to a scheduled DL shared channel. When performing the DCI monitoring for UL, the suspension of performing the monitoring may be ended based on a configured timer. The apparatus 1320 may be further caused to set and provide an initial value of the configured timer to the user device (similar to EHD 701/801/901/1001 and apparatus 1310 of FIG. 13). The initial value may be incrementally increased by an indication in the DCI for UL.

Various exemplary embodiments described above may provide several technical improvements, enhancements, and/or advantages. For instance, some exemplary embodiments may provide advantages for increasing transmission and reception reliability for an EHD with minimal additional control plane overhead. Certain exemplary embodiments may also advantageously provide relaxed PDCCH monitoring, which allows for more efficient usage of energy resources.

In some exemplary embodiments, an apparatus (e.g., apparatus 1310 and/or apparatus 1320) may include means for performing a method, a process, or any of the variants discussed herein. Examples of the means may include one or more processors, memory, controllers, transmitters, receivers, and/or computer program code for causing the performance of the operations.

Various exemplary embodiments may be directed to an apparatus, such as apparatus 1310, that may include means for receiving, from a serving cell (similar to serving cell 702/802/902/1002 and apparatus 1320 of FIG. 13), a configuration for a maximum number of DL and/or UL HARQ processes and means for providing an indication to the serving cell (similar to serving cell 702/802/902/1002 and apparatus 1320 of FIG. 13) that includes a desired maximum number of UL HARQ processes based on an energy level of the apparatus 1310 (similar to EHD 701/801/901/1001). The apparatus 1310 (similar to EHD 701/801/901/1001) may also include means for performing DCI monitoring for DL or UL until the maximum number of HARQ processes is reached. The DCI monitoring may be suspended when a corresponding maximum number of DL or UL HARQ processes is exceeded.

Various exemplary embodiments may be directed to an apparatus, such as apparatus 1320, that may include means for determining that a user device (similar to EHD 701/801/901/1001 and apparatus 1310 of FIG. 13) with an unreliable power source based on an indication received from the user device (similar to EHD 701/801/901/1001 and apparatus 1310 of FIG. 13). The apparatus 1320 (similar to serving cell 702/802/902/1002) may also include means for reconfiguring a maximum number of HARQ processes, and instructing the user device (similar to EHD 701/801/901/1001 and apparatus 1310 of FIG. 13) to operate in a half-duplex operation mode. The apparatus 1320 (similar to serving cell 702/802/902/1002) may also include means for performing DCI monitoring for DL and/or UL until the maximum number of HARQ processes is reached. The DCI monitoring may be suspended when a corresponding maximum number of DL or UL HARQ processes may be exceeded.

In some example embodiments, apparatuses 1310 and/or 1320 may include one or more processors, one or more computer-readable storage medium (for example, memory, storage, or the like), one or more radio access components (for example, a modem, a transceiver, or the like), and/or a user interface. In some example embodiments, apparatuses 1310 and/or 1320 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 13, apparatuses 1310 and/or 1320 may include or be coupled to processors 1312 and 1322, respectively, for processing information and executing instructions or operations. Processors 1312 and 1322 may be any type of general or specific purpose processor. In fact, processors 1312 and 1322 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 1312 (and 1322) for each of apparatuses 1310 and/or 1320 is shown in FIG. 13, multiple processors may be utilized according to other example embodiments. For example, it should be understood that, in certain example embodiments, apparatuses 1310 and/or 1320 may include two or more processors that may form a multiprocessor system (for example, in this case processors 1312 and 1322 may represent a multiprocessor) that may support multiprocessing. According to certain example embodiments, the multiprocessor system may be tightly coupled or loosely coupled to, for example, form a computer cluster).

Processors 1312 and 1322 may perform functions associated with the operation of apparatuses 1310 and/or 1320, respectively, including, as some examples, precoding of antenna gain/phase parameters, encoding and decoding of individual bits forming a communication message, formatting of information, and overall control of the apparatuses 1310 and/or 1320, including processes illustrated in FIGS. 5-12.

Apparatuses 1310 and/or 1320 may further include or be coupled to memory 1314 and/or 1324 (internal or external), respectively, which may be coupled to processors 1312 and 1322, respectively, for storing information and instructions that may be executed by processors 1312 and 1322. Memory 1314 (and memory 1324) may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 1314 (and memory 1324) can be comprised of any combination of random access memory (RAM), read only memory (ROM), static storage such as a magnetic or optical disk, hard disk drive (HDD), or any other type of non-transitory machine or computer readable media. The instructions stored in memory 1314 and memory 1324 may include program instructions or computer program code that, when executed by processors 1312 and 1322, enable the apparatuses 1310 and/or 1320 to perform tasks as described herein.

In certain example embodiments, apparatuses 1310 and/or 1320 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 1312 and 1322 and/or apparatuses 1310 and/or 1320 to perform any of the methods illustrated in FIGS. 5-12.

In some exemplary embodiments, apparatus 1310 and/or apparatus 1320 may also include or be coupled to one or more antennas 1315/1325 for receiving a downlink signal and for transmitting via an uplink from apparatus 1310. Apparatuses 1310 and/or 1320 may further include transceivers 1316 and 1326, respectively, configured to transmit and receive information. The transceiver 1316 and 1326 may also include a radio interface that may correspond to a plurality of radio access technologies including one or more of GSM, LTE, LTE-A, 5G, NR, WLAN, NB-IoT, Bluetooth, BT-LE, NFC, RFID, UWB, or the like. The radio interface may include other components, such as filters, converters (for example, digital-to-analog converters or the like), symbol demappers, signal shaping components, an Inverse Fast Fourier Transform (IFFT) module, or the like, to process symbols, such as OFDMA symbols, carried by a downlink or an uplink.

For instance, transceivers 1316 and 1326 may be respectively configured to modulate information on to a carrier waveform for transmission, and demodulate received information for further processing by other elements of apparatuses 1310 and/or 1320. In other example embodiments, transceivers 1316 and 1326 may be capable of transmitting and receiving signals or data directly. Additionally or alternatively, in some example embodiments, apparatuses 1310 and/or 1320 may include an input and/or output device (I/O device). In certain example embodiments, apparatuses 1310 and/or 1320 may further include a user interface, such as a graphical user interface or touchscreen.

In certain example embodiments, memory 1314 and memory 1324 store software modules that provide functionality when executed by processors 1312 and 1322, respectively. The modules may include, for example, an operating system that provides operating system functionality for apparatuses 1310 and/or 1320. The memory may also store one or more functional modules, such as an application or program, to provide additional functionality for apparatuses 1310 and/or 1320. The components of apparatuses 1310 and/or 1320 may be implemented in hardware, or as any suitable combination of hardware and software. According to certain example embodiments, apparatus 1310 may optionally be configured to communicate with apparatus 1320 via a wireless or wired communications link 1330 according to any radio access technology, such as NR.

According to certain example embodiments, processors 1312 and 1322, and memory 1314 and 1324 may be included in or may form a part of processing circuitry or control circuitry. In addition, in some example embodiments, transceivers 1316 and 1326 may be included in or may form a part of transceiving circuitry.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 1310 and/or 1320) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 1310 and/or 1320), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

Partial Glossary:
3GPP 3rd Generation Partnership Project
5G 5th Generation
ACK Acknowledgement
BSR Buffer Status Report
DCI Downlink Control Information
DL Downlink
DTX Discontinuous Transmission
EHD Energy Harvesting Device

EMBB Enhanced Mobile Broadband

gNB 5G or Next Generation NodeB

HARQ Hybrid Automatic Repeat Request
L1 Layer 1
L2 Layer 2
LTE Long Term Evolution
MAC Medium Access Control
NR New Radio
PDCCH Physical Downlink Control Channel
PDCP Packet Data Convergence Protocol
PDSCH Physical Downlink Shared Channel
PDU Packet Data Unit
PUSCH Physical Uplink Shared Channel
RAN Radio Access Network
RedCap Reduced Capability
RLF Radio Link Failure
RLC Radio Link Control
RRC Radio Resource Control
SR Scheduling Request
UE User Equipment
UL Uplink
URLLC Ultra Reliable Low Latency Communication

We claim:

1. An apparatus comprising:
at least one processor; and
at least one memory storing instructions that, when executed by the at least one processor, cause the apparatus at least to:
receive, from a serving cell, a configuration for a maximum number of downlink and/or uplink hybrid automatic repeat request (HARQ) processes;
provide an indication to the serving cell that comprises a desired maximum number of uplink hybrid automatic repeat request (HARQ) processes based on an energy level of the apparatus; and
perform downlink control information (DCI) monitoring for downlink or uplink until the maximum number of hybrid automatic repeat request (HARQ) processes is reached, wherein the downlink control information (DCI) monitoring is suspended when a corresponding maximum number of downlink or uplink hybrid automatic repeat request (HARQ) processes is exceeded.

2. The apparatus according to claim 1, wherein:
when the downlink control information (DCI) for downlink is detected, the apparatus is caused to monitor a search space until a maximum configured downlink hybrid automatic repeat request (HARQ) processes is reached; and
when the downlink control information (DCI) for uplink is detected, the apparatus is caused to monitor the search space until the maximum configured uplink hybrid automatic repeat request (HARQ) processes is reached.

3. The apparatus according to claim 1, wherein the downlink control information (DCI) monitoring is suspended for downlink and/or uplink when one of:
uplink layer 2 data is being transmitted, or
downlink layer 2 data is being received.

4. The apparatus according to claim 1, wherein the suspension of performing the downlink control information (DCI) monitoring is ended and monitoring is resumed after a processing time when a complete packet data convergence protocol (PDCP) or radio link control (RLC) segment is received by the apparatus.

5. The apparatus according to claim 4, wherein the complete packet data convergence protocol (PDCP) or the radio link control (RLC) segment is for control plane and/or user plane (U-plane).

6. The apparatus according to claim 4, wherein the processing time is defined or configured for control plane and is determined for user plane (U-plane).

7. The apparatus according to claim 6, wherein the processing time determined for the user plane (U-plane) is determined based on a transport block size or service data unit size.

8. The apparatus according to claim 1, wherein processing and transmitting or receiving of a complete packet data convergence protocol (PDCP) or radio link control (RLC) segment are sequential.

9. The apparatus according to claim 1, wherein:
when performing the downlink control information (DCI) monitoring for downlink, the suspension of performing the monitoring is ended based on transmitting uplink channel feedback corresponding to a scheduled downlink shared channel; and
when performing the downlink control information (DCI) monitoring for uplink, the suspension of performing the monitoring is ended based on a configured timer.

10. The apparatus according to claim 9, wherein an initial value of the configured timer is set and provided to the apparatus by the serving cell, wherein the initial value is incrementally increased by an indication in the downlink control information (DCI) for uplink.

11. The apparatus according to claim 1, wherein the apparatus is caused to indicate to the serving cell that the apparatus has an unreliable power source.

12. An apparatus comprising:
at least one processor; and
at least one memory storing instructions that, when executed by the at least one processor, cause the apparatus at least to:
determine that a user device with an unreliable power source based on an indication received from the user device;
reconfigure a maximum number of hybrid automatic repeat request (HARQ) processes, and instruct the user device to operate in a half-duplex operation mode; and
perform downlink control information (DCI) monitoring for downlink and/or uplink until the maximum number of hybrid automatic repeat request (HARQ) processes is reached, wherein the downlink control information (DCI) monitoring is suspended when a corresponding maximum number of downlink or uplink hybrid automatic repeat request (HARQ) processes is exceeded.

13. The apparatus according to claim 12, wherein the maximum number of hybrid automatic repeat request (HARQ) processes is reconfigured such that the user device operates to one of: (i) transmit a packet data convergence protocol (PDCP) or radio link control (RLC) segment or (ii) receive the packet data convergence protocol (PDCP) or radio link control (RLC) segment.

14. The apparatus according to claim 12, wherein the downlink control information (DCI) monitoring is suspended for downlink and/or uplink when one of:
uplink layer 2 data is being transmitted or
downlink layer 2 data is being received.

15. The apparatus according to claim 12, wherein the suspension of performing the downlink control information (DCI) monitoring is ended and the monitoring is resumed, after a processing time when a complete packet data convergence protocol (PDCP) or radio link control (RLC) segment is transmitted to the user device.

16. The apparatus according to claim 15, wherein the complete packet data convergence protocol (PDCP) or the radio link control (RLC) segment is for control plane and/or user plane (U-plane).

17. The apparatus according to claim 15, wherein the processing time is defined or configured for control plane and is determined for user plane (U-plane).

18. The apparatus according to claim 17, wherein the processing time determined for the user plane (U-plane) is determined based on a transport block size or service data unit size.

19. The apparatus according to claim 12, wherein processing and transmitting or receiving of a complete packet data convergence protocol (PDCP) or radio link control (RLC) segment are sequential.

20. The apparatus according to claim 12, wherein:
when performing the downlink control information (DCI) monitoring for downlink, the suspension of performing the monitoring is ended based on transmitting uplink channel feedback corresponding to a scheduled downlink shared channel; and
when performing the downlink control information (DCI) monitoring for uplink, the suspension of performing the monitoring is ended based on a configured timer.
